(19) United States
(12) Patent Application Publication
(10) Pub. No.: US 2017/0213259 A1
(43) Pub. Date: Jul. 27, 2017

(54) DISTRIBUTED DATA PROCESSING SYSTEM FOR AUTHENTICATING AND DISSEMINATING USER-SUBMITTED DATA OVER A WIDE AREA NETWORK

(71) Applicant: OpinionShield, Newport Beach, CA (US)

(72) Inventors: Victor Gruber, Costa Mesa, CA (US); Daniel Thomas Cwieka, Dana Point, CA (US); Timothy Scalzo, Lake Elsinore, CA (US)

(21) Appl. No.: 15/404,729

(22) Filed: Jan. 12, 2017

Related U.S. Application Data
(60) Provisional application No. 62/278,172, filed on Jan. 13, 2016.
(60) Provisional application No. 62/286,216, filed on Jan. 22, 2016.
(60) Provisional application No. 62/300,575, filed on Feb. 26, 2016.
(60) Provisional application No. 62/320,303, filed on Apr. 8, 2016.
(60) Provisional application No. 62/355,774, filed on Jun. 28, 2016.

(51) Int. Cl. G06Q 30/02; H04L 9/32; G06Q 20/04; G06Q 20/32; G06Q 20/40

(52) U.S. Cl. CPC G06Q 30/0282; G06Q 20/3223; G06Q 20/4014; G06Q 20/0453; H04L 9/3234; H04L 2209/56

(57) ABSTRACT

Systems and methods for providing electronic transaction verification and verified user submitted data may include a processor and a non-transitory memory device storing instructions that, when executed by the processor, cause the computing system to transmit, to a user device via a first communication network, a message including information corresponding to an executed electronic transaction. The processor receives, from the user device via the first communication network, an electronic verification message verifying the electronic transaction and causes the user device to display a user interface screen corresponding to the verified executed transaction, the user interface screen including user inputs for selecting a plurality of pre-defined data entry elements. The selected data entry elements may be used to generate verified user submitted data based on the received plurality of user inputs disseminated over a wide area network and/or over a plurality of interconnected networks.

### CROSS REFERENCE TO RELATED APPLICATION(S)

This application claims priority to provisional Patent Application No. 62/278,172 entitled

“Electronic Transaction Authentication System” and filed on Jan. 13, 2016, provisional Patent Application No. 62/286,216 entitled “Electronic Transaction Authentication System” and filed on Jan. 22, 2016, provisional Patent Application No. 62/300,575 entitled “Electronic Transaction Authentication System” and filed on Feb. 26, 2016, provisional Patent Application No. 62/320,303 entitled “Electronic Transaction Authentication and Transactional Opinion System” and filed on Apr. 8, 2016, and provisional Patent Application No. 62/355,774 entitled “Electronic Transaction Authentication and Transactional Opinion System” and filed on Jun. 28, 2016, all of which are incorporated by reference.

### FIELD OF THE INVENTION

This disclosure is generally directed to digital processing systems and multi-computer data transferring. More particularly, this disclosure is directed to distributed data processing and cooperative computer processing using interconnected networks in which multiple, separate computers share and jointly operate on user-submitted data to perform different tasks to accomplish an overall goal of authenticating the user-submitted data. More specifically, this disclosure is directed to an electronic authentication system for authenticating user-submitted data characterizing electronic communications between parties and disseminating verified user-submitted data over a wide area network and/or a plurality of interconnected networks.

### BACKGROUND

Existing computing systems for facilitating electronic publication of consumer opinions have minimal functionality for providing an indication that an individual has actually purchased the product or service subject to the review. Currently, no regulation exists for managing electronic transaction verifications allowing for embellished statements to be widely published and accessible via the Internet, and other electronic outlets, without requiring or providing proof that the purchase has taken place. For example, existing third-party publishers of electronic ratings and reviews have not implemented or emphasized purchase verification computing systems for many reasons including fear of hindering consumer statement volume. Currently, inherent incompatibilities between the proprietary computing systems used by different payment processors inhibit the generation of common format electronic purchase notifications and/or receipts. Because of this, reviewers can often manipulate ratings algorithms processed by computing systems of rating services and/or the rating computing systems of online retailers by skewing user reviews and/or ratings enough to adversely affect businesses through false reviews and/or ratings. In some cases, many rating services and/or companies may manipulate ratings of their products and/or services by determining which, if any, reviews and/or ratings submitted by customers are to be published and/or determining how long such reviews are to be published and incorporated into an overall review score. In some cases, bad actors may create many false user profiles to provide these false reviews. Additionally, in some cases, legitimate user profiles may be compromised to facilitate a campaign to discredit a retailer, a business, or the user associated with the compromised user account.

With the advent of online marketplaces and/or service providers, electronic transactions and reviews of the goods and/or services have become common place and may be subject to abuse in swaying public opinion for (or against) a product, service, merchant, service provider and/or the like. Online reviews have become diluted or contaminated, for many varied reasons that may include a lack of regulation, a lack of auditability, and/or inadequate systems implementation. Review fraud has become so problematic that companies have formed to provide systems and services that were designed to purposely camouflage poor consumer reviews with positive ones. In 2016 for example, 23.8 million reviews were not recommended by a well-known ratings service. An additional 7.9 million reviews had been removed from the rating service's platform, many due to violation of the rating service's terms of service. Additionally, many of the reviews may have been made by people who never purchased the product or service, and the reviews may include reviews of products not yet released. Such reviews are evidence of review systems that are not auditable and have no or little authenticity and/or credibility.

A review publisher's business model may be based on quantity and thus purposely used to omit certain or important details with the intention of increasing review quantity for advertising purposes or revenue building. The review publisher's business model currently allows reviews to be published without submitting actual proof of purchase, which facilitates publication of fake or otherwise improper reviews. Also, the review publisher's current business model may allow the merchant or business to control what reviews get published online, and which can be hidden from view. By withholding material details such as the actual purchase amount of the product or service, a user or reviewer may “create a mountain out of a molehill,” and may obfuscate any actual issue that may have occurred. Additionally, the review publisher's current business model allows for vague or ambiguous information to be posted in a negative (neutral or positive) review. Often time reviewers that hide behind such anonymity may do so with the intent to cause harm to a merchant. Additional confusion may result from review software that allows merchants to select only the consumer reviews they want to publish thereby burying any negative reviews, whether true or not. As such, a need has been recognized for distributed computing systems configured to provide an electronic transaction verification including an amount of the purchase, that may be used, across a variety of unrelated computing systems, to provide a verified electronic opinion or statement about a business, a product, service, and/or transaction experience including the purchase amount, while concurrently integrating a simple and effective way to authenticate purchases with the consumer, thus allowing a consumer to generate a review of a completed transaction and incorporate an electronic proof of purchase along with a published review to provide an auditable record of the complete transaction and electronic publication of the review.

### SUMMARY

Aspects of the disclosure provide effective, efficient, scalable, and convenient technical solutions that address and overcome the technical problems associated with providing electronic verification of electronic financial transactions and associating the verified financial transaction with a verified opinion statement.

Systems and methods for providing electronic transaction verification and verified user submitted data may include a processor and a non-transitory memory device storing instructions that, when executed by the processor, cause the computing system to transmit, to a user device via a first communication network, a message including information corresponding to an executed electronic transaction. The processor receives, from the user device via the first communication network, an electronic verification message verifying the electronic transaction and causes the user device to display a user interface screen corresponding to the verified executed transaction, the user interface screen including user inputs for selecting a plurality of pre-defined data entry elements. The selected data entry elements may be used to generate verified user submitted data based on the received plurality of user inputs disseminated over a wide area network and/or over a plurality of interconnected networks.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative electronic transaction verification and transactional opinion computing system according to aspects of the disclosure;

FIG. 2 shows another illustrative electronic transaction verification and transactional opinion computing system according to aspects of the disclosure;

FIG. 3 shows an illustrative method for providing electronic transaction verification and a verified opinion associated with an electronic transaction according to aspects of the disclosure;

FIGS. 4A and 4B show illustrative electronic receipts according to aspects of the disclosure;

FIGS. 5A and 5B show illustrative electronic receipts according to aspects of the disclosure;

FIGS. 6A-6C and 7A-7C show illustrative user interface screens for user registration and user profile configuration for the illustrative electronic transaction verification and transactional opinion computing system according to aspects of the disclosure;

FIGS. 8A-C and 9A-9C show illustrative user interface screens information associated with verified electronic transactions and for providing a verified opinion according to aspects of the disclosure;

FIGS. 10A and 10B show illustrative user interface screens for providing private messaging between a user with a verified transaction and a provider according to aspects of the disclosure;

FIG. 11 shows an illustrative user interface screen for a business search interface according to aspects of the disclosure;

FIG. 12 shows an illustrative incentive overview user interface screen according to aspects of the disclosure;

FIGS. 13A and 13B show illustrative user interface screens for allowing a user to associate a financial account to their user profile according to aspects of the disclosure;

FIGS. 14-17 show illustrative user interface screens showing an overview of company and consumer information according to aspects of the disclosure; and

FIGS. 18A-D show illustrative phrases used in generating a verified opinion statement and transaction score according to aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

In view of the aforementioned problem(s), the electronic transaction authentication system disclosed may establish a method for internal and external regulation of acquiring a consumer's transaction statements, providing verification of the transaction, receiving an input from the user opting-in to the verified opinion statement publication service and granting publishing rights to the verified opinion statement, publishing a publically accessible and auditable verified opinion statement including a purchase amount and providing a private verified opinion to the owner of the business (or assigned management) along with a private messaging service in which the customer and business may privately communicate regarding the transaction and/or transaction experience. An electronic text (“e-text”) receipt, such as an e-Text™ receipt provided by OpinionShield™, may be initiated based on the user's electronic banking statements or at the point of transaction. The e-text receipt may provide a person, or business entity, a two-way messaging notification utilizing one or more of a messaging application, a verified opinion application, and/or the like, that may be used to verify an associated transaction and establish a proof of purchase for products, services and transaction experiences. The system may guide a consumer through creation of an opinion statement regarding a transaction and/or a transaction experience, thus translating the customer's opinion into a format similar to a professionally edited statement.

Financial institutions and/or other providers of some form of consumer or business credit, such as credit cards, automated clearing house (ACH) transfers, debit accounts, reloadable charge cards, bank cards, store cards, gift cards, and the like are working to improve features associated with their accounts (e.g., rewards programs, etc.) to gain and/or retain customers. In some cases, an improved understanding of a current rewards program may prevent customers from searching for a replacement to an existing card and/or other exiting payment method by shopping for a new primary card. For example, a credit card issuer may provide services to provide a secure electronic transaction platform for use by its customers and/or to increase communication with clients through some form of electronically disseminated service alerts.

An electronic transaction authentication system may be configured for use as a centralized, or distributed, computing system to authorize transactions, such as by using an electronically communicated and validated e-text receipt. This computing system may be used to establish an electronic authentication system for internal and external regulation of transactions made by a plurality of consumers. An e-text receipt may be used to provide an individual proof of purchase for products, services, and the overall business transaction experience. The electronic transaction verification and transactional opinion computing system may provide a series of user interface screens used to guide a purchaser through articulating a transaction statement and transaction experience, and may then translate the transaction statement into a translated purchaser's statements into a professional and useful opinion.

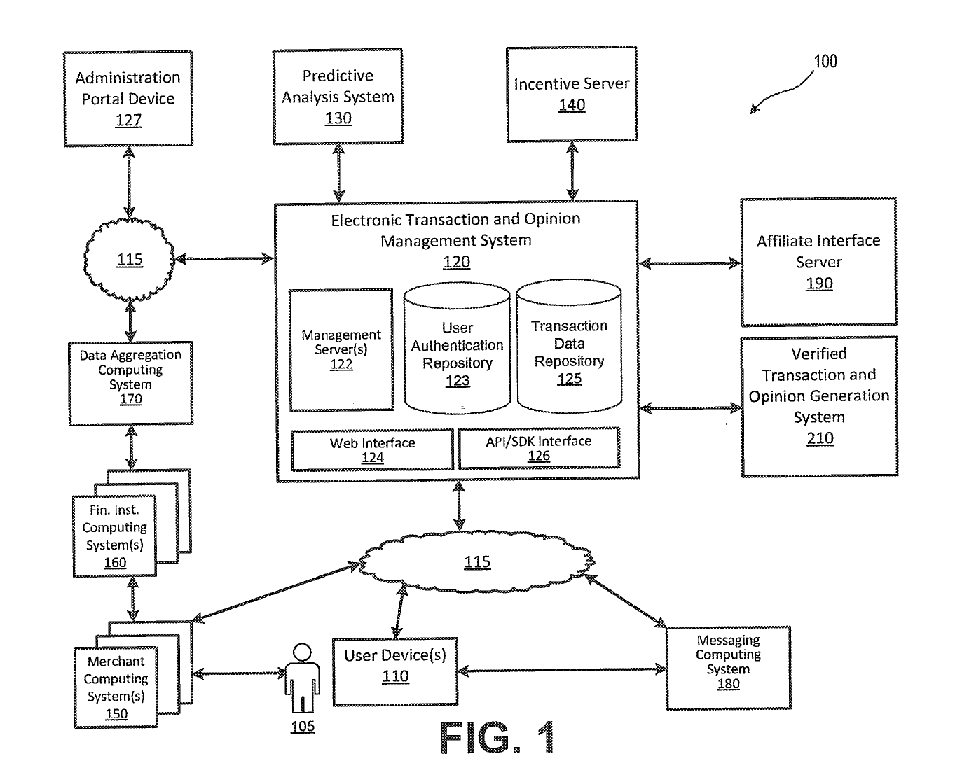

FIG. 1 shows an illustrative electronic transaction verification and transactional opinion computing system 100 according to aspects of the disclosure. The electronic transaction verification and transactional opinion computing system 100 may include an electronic transaction and opinion management system 120 communicatively coupled to a verified transaction and opinion generation system 210. The electronic transaction and opinion management system 120 may be communicatively coupled via a network 115 (e.g., a wide area network (WAN), a local area network (LAN), a telecommunications network, a cable communications network, the Internet, etc.) to a plurality of user devices (e.g., personal mobile devices, laptop computers, desktop computers, tablet computing devices, wearable computing devices, etc.) to facilitate interaction by a user 105 to verify one or more electronic transactions and/or to provide verified opinion statements regarding products and/or services purchased by the user 105. The user 105 may purchase a product or service from a merchant (e.g., a company, vendor, store, manufacturer, service provider, etc.) in person, via a telecommunications device (e.g., a phone, etc.), via the Internet (e.g., a consumer accessible website, etc.) and the like. The purchase may be processed by the merchant via a merchant computing system 150, which may communicate the purchase transactional information to the financial institution computing system 160 to authenticate and complete the purchase. The electronic transaction and opinion management system 120 may be communicatively coupled via the network to a plurality of financial institution computing systems 160, either directly or via a data aggregation computing system 170. In some cases, the electronic transaction and opinion management system 120 may communicate to the user 105 via the user device 110, such as by communicating a message via a messaging computing system 180. In some cases, the message communicated by the electronic transaction and opinion management system 120 may include an electronic receipt (e.g. an e-text receipt), as a text message, an email, an in-application message, and/or the like. In some cases, an authorized user, such as a merchant representative, a salesman, a marketer, an administrator, etc., may access information through the electronic transaction and opinion management system 120 via an administration portal device 127 through the network 115, such as via a web browser interface, a dedicated application interface, and/or the like. The electronic transaction and opinion management system 120 may utilize a predictive analysis system 130 and/or an incentive server 140 to incentivize the user 105 to electronically verify a transaction and to provide a verified opinion statement corresponding to a product or service associated with the transaction. The predictive analysis system 130 may be used to analyze a plurality of verified opinion statements to provide competitive market analysis of user sentiment which may be presented via the administrative portal device. In some cases, the electronic transaction and opinion management system 120 may be integrated with one or more affiliate interface servers, such as the affiliate interface server 190, by utilizing functions provided through an application programming interface (API) and/or a software development kit (SDK).

In some cases, the electronic transaction and opinion management system 120 may include one or more management servers 122, one or more data repositories (e.g., a user authentication repository 123, a transaction data repository 125, etc.), and a communication interface (e.g., a web interface 124, an API/SDK interface, etc.) to facilitate communication via the network 115 to the user devices 110, the messaging computing system 180, the affiliate interface server 190, the administration portal device 127, the data aggregation computing system 170 and/or the financial institution computing systems 160.

In some cases, the electronic transaction and opinion management system 120 of the electronic transaction verification and transactional opinion computing system 100 may receive an indication of a transaction made by a user and generate an e-text receipt for authentication by the user. The e-text receipt may include a purchase receipt identifier and a customer identifier that, upon user verification, comprises a “proof of the purchase” associated with an authenticated user, thus providing an authenticated and validated purchase verification. This validated purchase verification may, in some cases, be associated with a particular user identifier, which may be used to provide an indication of authenticity of the individual and/or business that may publish a review and/or rating of a product, service and/or a provider of the product or service via a verified opinion statement

A portion of the electronic transaction verification and transactional opinion computing system 100 (e.g., the predictive analysis system 130) may process instructions of specially programmed components of the computing system to perform at least a portion of an integrated technique that is designed to provide validation of electronically entered user inputs that may be received over a wide area network and/or a plurality of interconnected communication networks with respect to an electronically disseminated opinion statement and/or rating when publishing their articulated transaction experience. The instructions may also configure the electronic transaction verification and transactional opinion computing system to capture specific customer or business transaction receipt information at the point of transaction, allowing the electronic transaction and opinion management computing system 120 the immediate opportunity to acquire then generate a “Purchase Transaction Statement” or “Electronic Opinion Statement form” for providing the integrated purchase support information that may be used to generate credible, verifiable, meaningful customer perspective of their transactions.

In some cases, the electronic transaction and opinion management system 120 may include an API, or other such code (e.g., an SDK), to be processed at the “point of transaction” (e.g., an electronic cash register, a mobile device, a laptop computer, a desktop computer, a purchasing server associated with a website, etc.) to facilitate verification of the transaction by the user 105. In some cases, function of the API and/or SDK may be implemented at the affiliate interface server 190, which may coordinate communication of information to the electronic transaction and opinion management system 120 from one or more merchant computing systems 150. In some cases, functions of the API and/or the SDK may be implemented in the merchant computing systems 150 such as to identify a user registered with the electronic transaction and opinion management system 120 and/or may be used to offer registration opportunities to a user not already registered. In some cases, the financial institution computing systems 160 may implement one or more functions of the API and/or SDK in the financial institution computing system 160 to facilitate communication of transactions to the data aggregation computing system 170, such as a third-party electronic transaction aggregation system and the like. In some cases, the data aggregation computing system 170 may include a big data computing system for storing and/or analyzing large amounts of transaction information.

In some cases, the user 105 may be registered with the electronic transaction and opinion management system 120 through a webpage interface, a software application interface, a mobile device application interface, a telephone interface, etc. In an illustrative example, a user may download an application to a personal device, such as a mobile phone or other personal mobile device. Upon launching the application, the user 105 may be prompted to register with the electronic transaction and opinion management system 120 to create a registered user account and/or may be asked to login to the application using existing registration and/or authentication credentials associated with a registered user account.

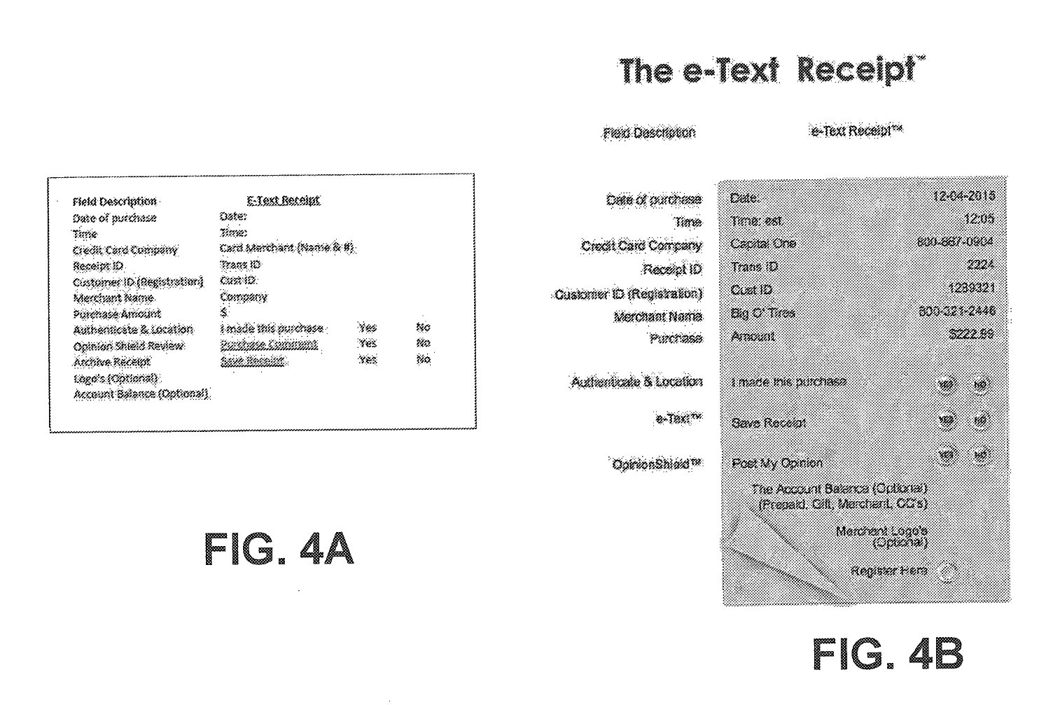

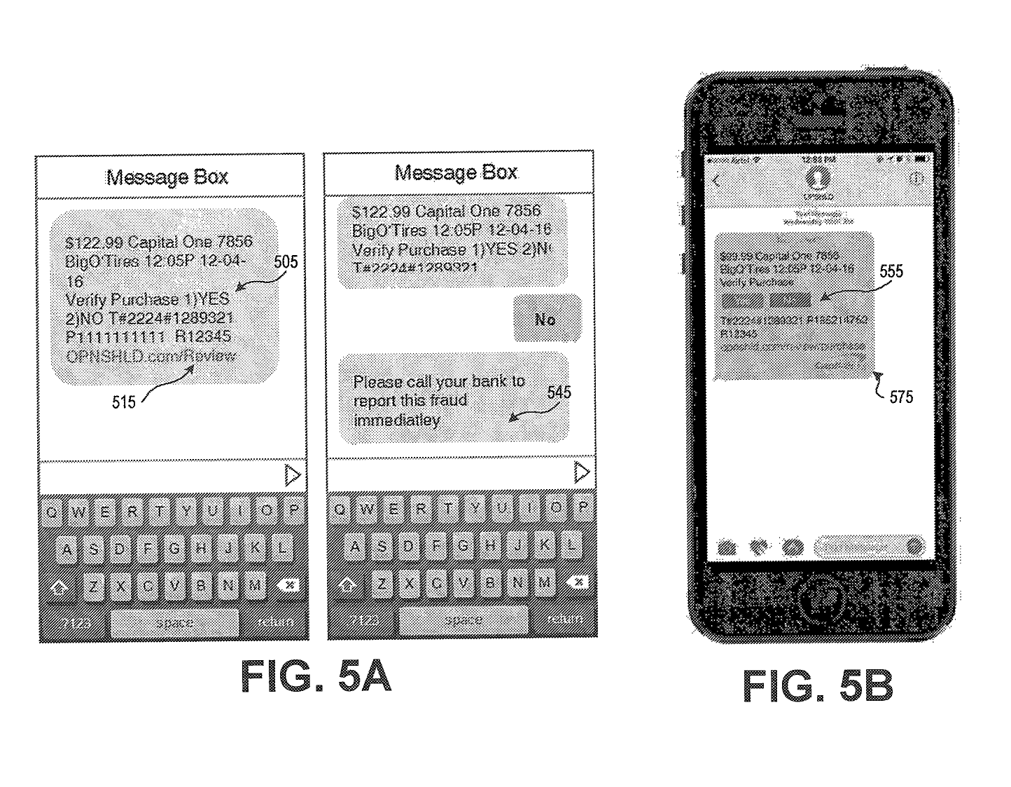

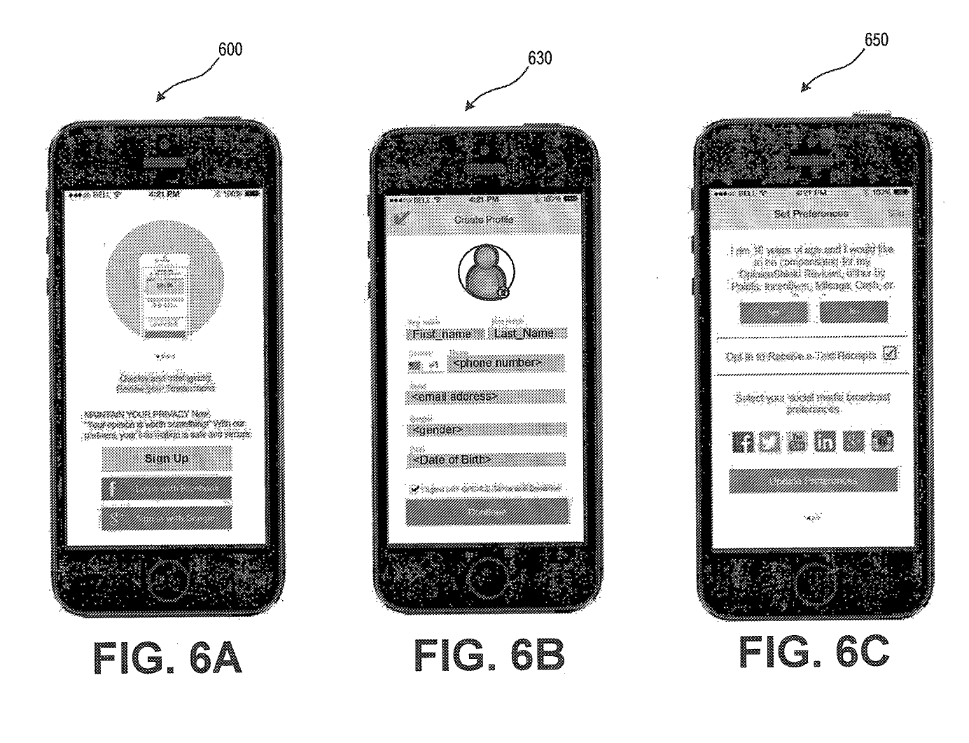

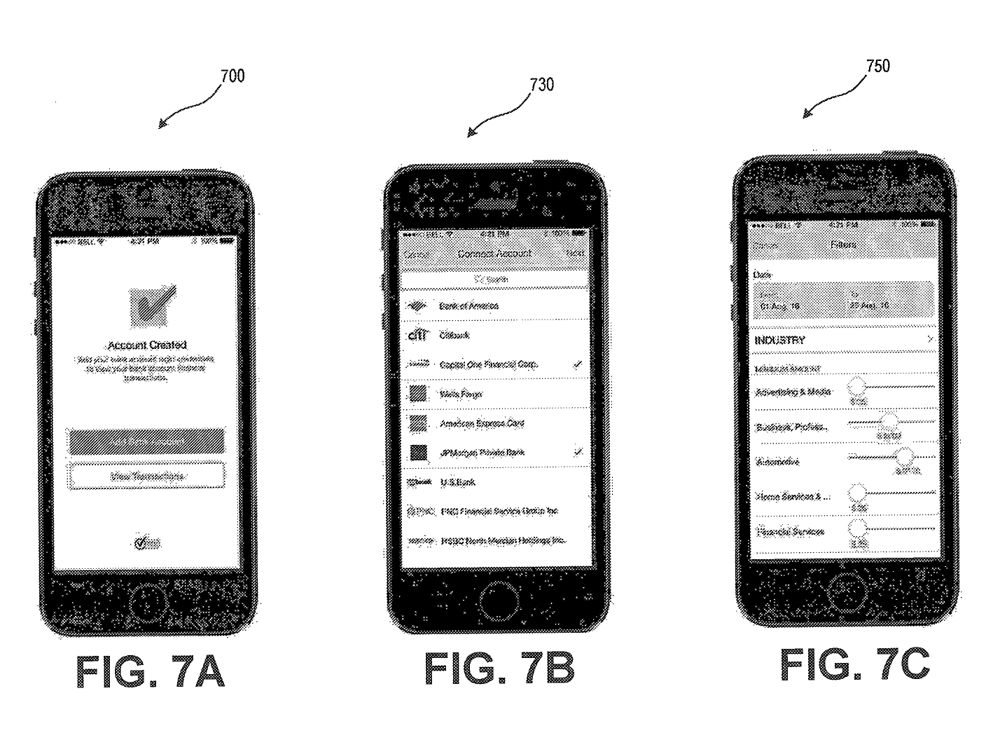

Illustrative user interface screens for an application running on a mobile device for registration and user account configuration are shown in FIGS. 6A-6C and 7A-7C. For example, upon launching the downloaded application on the user device 110, the user 105 may be presented with the user log-in screen 600 of FIG. 6A that may include one or more user inputs prompting the user to login or sign up for an account. In some cases, the user may be able to generate a new user account by logging in using credentials from a third-party social network, and/or the like. To create a user account, the user 105 may be presented with the user identification screen 630 of FIG. 6B and may be prompted to enter their name (e.g., first name, last name, user display name, and/or the like), contact information (e.g., an email address, a mailing address, a phone number, etc.), gender information, date of birth, security questions and/or answers, and/or the like. The user 105 may also be prompted to agree with identified terms and conditions associated with use of the electronic transaction and opinion management system 120, as presented via a link. Once entered, the user may select an input to continue the user registration and/or user profile configuration process. FIG. 6C shows an illustrative user interface screen 650 for setting user preferences. In some cases, the user interface screen 650 may include a user consent agreement between the user and the provider of the electronic transaction verification and verified user opinion generation system 100, where the user may provide an agreement input (e.g., press a “yes” button) to agree to participate and/or be compensated or incentivized in their use of the system such as by providing a verified opinion statement. In some cases, the user 105 may select a disagreement input (e.g., press a “no” button) to decline to participate in providing verified opinion statements. The user may agree or decline to participate at any time, and may modify their participation selection, after the user account has been set up such as by accessing a user preference screen in the mobile application. Additionally, the user may elect to receive electronic receipts (e.g., e-text receipts), such as those shown in FIGS. 4A, 4B, 5A, and 5B, by selecting an opt-in input (e.g., marking a checkbox, selecting an affirmative input, etc.) The user interface screen 650 may also include one or more other preferences, such as selecting one or more social media networks in which to publicize or otherwise communicate, a verified opinion statement entered by the user.

Once the user account has been created, or upon editing an existing user account, the user may be presented with a user interface screen 700 in which the user 105 may be prompted to configure one or more financial accounts in which financial transactions may occur and may be desired to be verified. For example, the user may select an input (e.g., an “add bank account” input button) so that the user may enter information associated with one or more financial accounts that the user 105 wishes to link to the electronic transaction and opinion management system 120. Upon linking the account, the electronic transaction and opinion management system 120 may request and/or receive transaction information associated with the one or more linked accounts from the data aggregation computing system 170, the financial institution computing system(s) 160 and/or the merchant computing system(s) 150. In some cases, the data aggregation computing system 170, the financial institution computing system(s) 160 and/or the merchant computing system(s) 120 may be capable of providing such information through use and/or implementation of one or more API functions, SDK functions, and/or the like. Upon selection of the “add bank account” input, one or more financial accounts (e.g., debit accounts, savings accounts, checking accounts, revolving credit accounts, credit card accounts, debit card accounts, and/or the like) may be linked to the user profile via one or more additional user interface screens, such as the user interface screen 730 of FIG. 7B. The user interface screen 730 may include a list of one or more financial institutions, that may be in common use by individuals nationally, in a geographic region close to the user 105, and/or the like. The user 105 may also utilize a search input field to find other financial institutions that may not already be listed (e.g., local banks, credit unions, merchant credit cards, etc.). Once selected, the user may be presented with an encrypted financial account set-up screen (not shown) in which a user may enter information associated with that account, such as a user identifier, password and/or other verification information, etc., which may be communicated via a secure communication link between the mobile device 110, the electronic transaction and opinion management system 120, and the financial institution computing system(s) 160. Once an account has been configured and/or linked to the registered user account, the user interface screen 730 may display a verification indication, such as a check mark, highlighting, or other such visual verification indicators.

Additionally, the user 105 may be presented with a user interface screen 750, such as a user interface screen of a dedicated application running on the user device 110, for configuration of transaction notification preferences of the user, receiving a user input granting publishing rights to a generated verified opinion statement, etc. For example, the user 105 may not desire to receive notifications to verify purchases of a certain type and/or under a specified dollar amount, and instead may want to filter out certain transactions. For example, the electronic transaction and opinion management system 120 may allow a user to filter classified transactions by a category associated with a product or service provided by the merchant and/or service provider. For example, transaction classification may include, but not be limited to, advertising and media transactions, business or professional service transactions, automotive transactions, home services transactions, financial services transactions, travel transactions, leisure transactions, food and beverage transactions, and/or the like. The user interface screen 750 may present to the user 105 a listing of categories, by industry, by product type, by geographic location, and/or the like. For each category, a default amount may be set (e.g., about $25, about $50, etc.) as a minimum transaction amount. The user 105 may then selectively set a minimum amount to filter out transactions not meeting the specified minimum amount. For example, for business or professional services, a user may desire to not receive verification notices for amounts less than a certain dollar amount (e.g., about $2000). For automotive services, or other categories, the user may selectively enter a same amount or different amount, for each of the different categories. In some cases, the user 105 may configure the filters to be active for a specific period of time (e.g., about 1 day, about 1 week, about 1 month, etc.), or may set the filters to be active continually, until specifically modified by the user 105.

Returning to FIG. 1, once the user 105 has registered, the user account information may be stored by the electronic transaction and opinion management system 120 in one or more data repositories, such as the user authentication repository 123, a user account repository, a user preference repository, and/or the like. The management servers 122 may process instructions, such as API functions, SDK functions and/or the like, to request transaction information corresponding to one or more financial transactions between the user 105 and a merchant via the merchant computing systems 150 through requests to the data aggregation computing system 170 and utilizing the filter preferences set by the user. In some cases, the electronic transaction and opinion management system 120 may provide the filter information to the data aggregation computing system 170 to filter the user transactions before being communicated to the electronic transaction and opinion management system 120. In some cases, the electronic transaction and opinion management system 120 may receive all, or most, of the user transactions monitored by the data aggregation computing system, where the electronic transaction and opinion management system 120 may apply the filters after receipt of the transaction information. Such transaction information may be stored in one or more data repositories, such as the transaction data repository 125. In some cases, a single transaction data repository may be used. In some cases, a data repository may be associated with each user 105 of the electronic transaction and opinion management system 120. In some cases, the unverified transaction information may be stored in a same data repository as the verified transaction information. In some cases, separate data repositories (e.g., a verified transaction data repository, an unverified transaction data repository, etc.) may be used for all users, a group of users, individual users or the like.

In some cases, the electronic transaction verification and transactional opinion computing system may include one or more incentive modules, implemented through use of specialized computing code, such as a payment system corresponding to a submitted electronic opinion (“e-opinion”) statement (e.g., a “Your Opinion Is Worth Something” program, Consumer & Merchant Co-ops, credit card reward program integration such as a “Cash for points” program, etc.) This incentive module may use consumer opt-in or opt-out information, user preference information, opinion statements, as well as their transaction experience in determining an incentive to offer to the user. In some cases, a reporting module may process instructions that may be used to generate a “Merchant Rating Score” for each merchant for which a validated e-opinion statement has been issued, which functions similarly to credit scores/ratings. Content can be segregated by business sectors or channels. The user 105 may opt-in to particular incentives or incentive plans through user preference screens in an application, or web interface, accessed via a user device and associated with the user's profile.

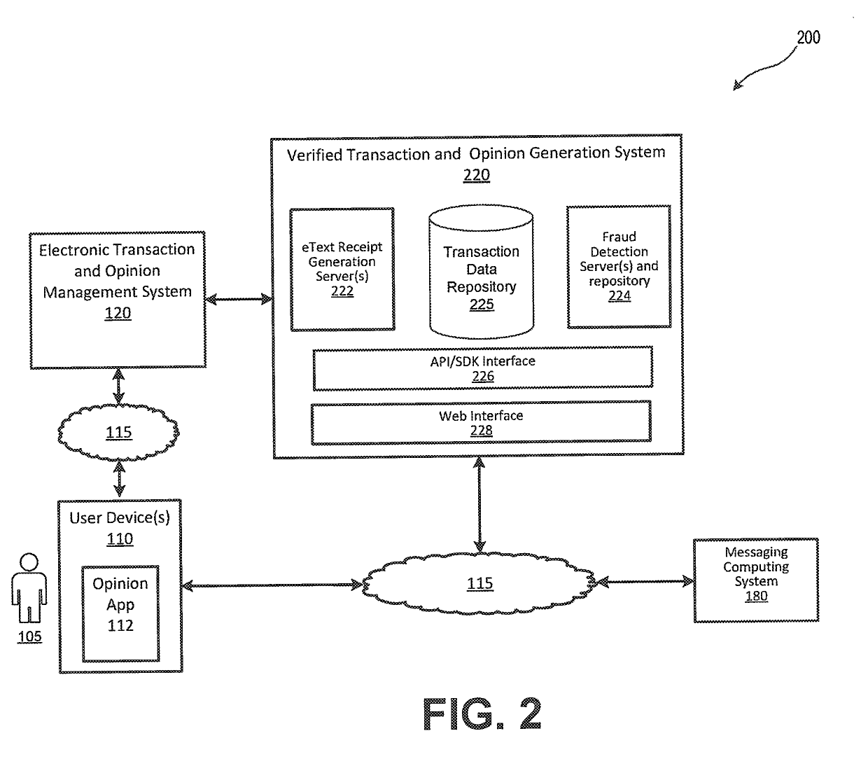

FIG. 2 shows an illustrative electronic transaction verification and transactional opinion computing system 200 according to aspects of the disclosure. The electronic transaction verification and transactional opinion computing system 200 may include the electronic transaction and opinion management system 120, the verified transaction and opinion generation system 220, the user device(s) 110 associated with one or more users, and the messaging computing system 180, all of which may be communicatively coupled via one or more wired or wireless links (e.g., the network 115). The verified transaction and opinion generation system 220 may include one or more data repositories (e.g., the transaction data repository 225, an opinion statement data repository (not shown), a user account information repository, etc.), an e-text receipt generation server 222, a fraud detection server and data repositories 224, an API/SDK interface 226, a web interface 228 and/or the like.

When the registered user initiates a purchase or transaction process, this initiation of the purchase or transaction process may allow the user to receive the e-text receipt, from their transaction, such as at a mobile device (e.g., the user device 110). The electronic transaction verification and transactional opinion computing system may integrate a portion of the system (e.g., an API interface, an SDK interface, a function call, etc.) the system used in conjunction with online e-commerce shopping cart software at one or more merchant computing systems 150. The user may initiate one or more financial transactions for products and services using a payment method including use of an automated clearinghouse ACH, credit cards, debit cards, reloadable charge cards, bank cards, store cards, gift card, company payment networks, and/or gateways that may include, but not be limited to a particular provider, and/or other electronic systems providers. In some cases, the API, or other functional modules may be provided to one or more receipt gateways, shipping and tracking software, and/or texting facilitator's systems, for use at the point of transaction and for use in importing the necessary content to the electronic transaction and opinion management system 120 and/or the verified transaction and opinion generation system 220. This information may be used to enable and/or initiate a “Purchase Transaction Statement” (e.g., an e-text receipt) or the purchaser's “Electronic Opinion Statement” for each verified transaction. Additionally, the Purchase Transaction Statement content may be populated from one or more different sources such as the e-text receipt, online e-commerce shopping cart software, merchant payment processing software and/or the like.

The components of the electronic transaction verification and transactional opinion computing system 100, such as the electronic and opinion management system 120, the verified transaction and opinion generation system 220 may be integrated with, or may be include a communication interface (e.g., an API interface, etc.) at one or more financial institution computing systems, a data aggregation computing system, such as through a licensed API use, to generate a structured e-text receipt. The e-text receipt, as initiated at the point of transaction and generated by the e-Text receipt generation server 222, may be electronically communicated over one or more networks (e.g., the Internet, a telecommunications network, a cable network, etc.), such as by the messaging computing system 180, via a text message, an email, and/or a user interface screen to the user device 110, such as a cell phone, a personal electronic device, a laptop computer, a desktop computer, and/or the like, if a user has “opted-in” (e.g., registered, etc.) to receive such messages. In some cases, the e-text receipt may be communicated to the user via a two-way messaging system (e.g., a text messaging system, an email system, etc.) such that the user may receive notice of an electronic transaction and provide one or more inputs that may be used to verify such transactions. The structured e-text receipt may be used to validate the purchase and/or specific transaction details. The e-text receipt may then be associated with the purchased product or service, the merchant or service provider providing the product and/or service, and the user making the purchase. Once verified, the user may be presented, via a user interface screen in an application (e.g., a transaction verification and opinion generation application 112), for use in generating a validated electronic opinion statement.

In some cases, the electronic transaction opinion management system 120 and/or the verified transaction and opinion generation system 220 may include an associated system application (e.g., the opinion application 112, etc.) that may be accessed through use of a mobile device (e.g., a cellular phone, a tablet computer, etc.) and/or other computing devices (e.g., a laptop computer, a desktop computer, etc.). In some cases, the electronic transaction opinion management system 120 and/or the verified transaction and opinion generation system 220 may be configured to work with a third party data center, such as the data aggregation computing system 170. The verified transaction and opinion generation system 220 may send a distinctively structured e-text receipt to a consumer via a messaging computing system 180 and/or the web interface 228 after completion of a transaction by the consumer and/or to the associated business, after completion of the transaction payment, such as with a credit, debit, gift, or prepaid card and/or the like. For the purpose of description, the terms “consumer,” “customer,” and “purchaser” may be used interchangeably. Similarly, “credit card purchases” may also imply the use of debit cards.

The systems and methods discussed in the present disclosure (e.g., the Opinion Shield™ system, etc.) may include a directly controlled process, a systems integrated process through use of an application programming interface (API) and/or a software development kit (SDK), and/or through contractual disinterested “Third Party” processes implementing the API and/or SDK to provide a structured e-text receipt that may be initiated from the users bank statements, at the “point of transaction,” at an online purchase location, and/or may be positioned on a website's shopping cart for selection before the purchaser initiates the transaction such as by use of a direct consumer credit card swipe, a telephonic credit-card purchase, an ACH transactions with a business merchant and/or the like. In some cases, the systems and methods discussed herein may be used to confirm and capture purchase details and/or user information that may allow the user to grant permission to acquire the publishing rights to a user opinion, before the user writes a statement about the purchased product, service and/or the purchase experience. In some cases, the permissions may be granted at the time, or just after the time of purchase at the point of business transaction.

In some cases, the e-text receipt may be used to create “a gateway” via an API and/or SDK driven interface, which may be licensed by certain clients for installation on their own computing systems to confirm consumer purchases and then capture and archive specific receipt and transaction information (e.g., a purchase confirmation, pricing information, receipt details, mobile device location information, transaction opinions, etc.) for future use, re-transmitting, publishing, sorting and/or archiving purposes regarding the purchase and/or the purchase experience for the purchaser and/or one or more transacting related or non-related parties. The e-text receipts may be used to validate a particular purchase, the purchaser and/or one or more transaction details before authorizing an electronic opinion statement form. E-text receipts may include information regarding the date of a purchase, time of the purchase, an associated financial institution (e.g., a credit card company, etc.), a receipt identifier, a customer identifier, a merchant identifier (e.g., a store name, etc.), a purchase amount, authentication and location information of purchase (e.g., a positive answer to a statement prompt such as “I made this purchase”—yes/no), and/or a link that directs users to the electronic opinion statement form. The link may allow users to save the e-text receipt data. Optionally, an e-text receipt may include logos and/or an account balance using API and/or SDK functions, such as the logos and/or names of third parties utilizing the API and/or SDK interface. For example, an e-Text™ receipt may include a watermarked or otherwise included logo or name, included in the e-Text™ receipt utilizing an API function call to include text and/or graphic information into the e-Text™ receipt.

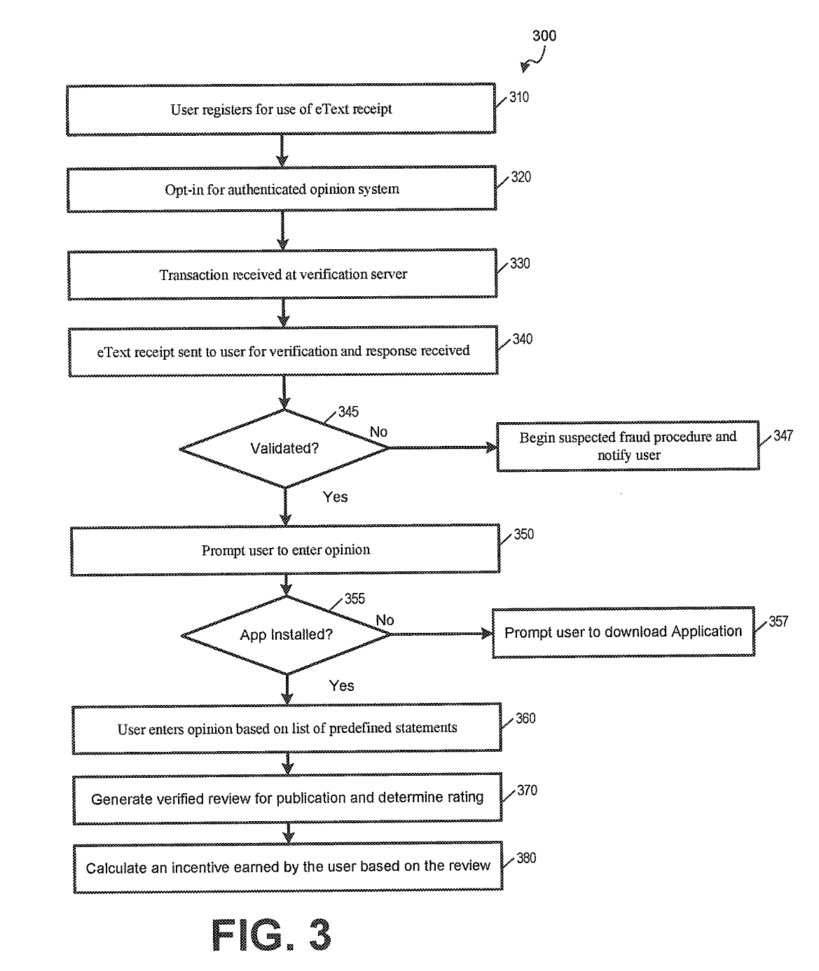

FIG. 3 shows an illustrative method 300 for providing electronic transaction verification and a verified opinion associated with an electronic transaction according to aspects of the disclosure. At 310, a user may register for use of an e-text receipt and/or to provide verified opinion statements. In some cases, the user may download an application to a mobile device or otherwise install a verified opinion generation application onto a personal computing device. The user may then register through the application. In some cases, the user may receive an email or other online notification during an electronic transaction, such as via a link or pop-up window generated, for example, at checkout of an online shopping cart system of a merchant. In some cases, the user may receive an email, text message (e.g., an SMS message, a MMS message, an application based message notification, etc.), or other notification from an in-person visit to a merchant and sign up via the message or through the merchant computing system 150 at checkout. Once registered, at 320, the user may opt-in to participate in a verified opinion generation and publication system. In some cases, the opt-in process may include the user agreeing to license publication rights to the verified opinion statements in return for incentives, rewards, and/or other compensation. Such rewards may be generated and/or received electronically in response to a completed opinion statement being generated and associated with a verified transaction.

At 330, an electronic transaction may be received from a merchant computing system 150 at a financial institution computing system 160 for processing. After verification and processing, transaction information may be communicated to a data aggregation computing system 170 before being communicated to the electronic transaction and opinion management system 120 based on user profile information including associated financial accounts. At 340, the user may receive notification of an electronic transaction via an e-text receipt being received at a user device received from the verified transaction and opinion generation system 210. In some cases, the e-text receipt may be received in a 2-way text-messaging system. In some cases, the e-text receipt may be received via the verified opinion application and/or a web interface, email interface and/or the like. The user may then verify the transaction via the two-way communication system, thereby creating a validated consumer transaction for which a verified opinion may be associated. If the transaction is not validated by the user at the user device, at 345, the transaction may be flagged as being fraudulent and notice may be communicated to the user via the two-way messaging interface and/or to the financial institution computing system. If validated at 345, the user may be prompted to enter their validated opinion at 350.

At 355, the user device may be checked to ensure the application 112 has been installed on the user device 110, so that the user may enter the verified user opinion statement via the user interface screens of the application 112. If not, the user may be prompted to download the application at 357.

If the application had been installed at 355, the application 112 may display one or more user interface screens to facilitate user rating of the transaction. For example, the user interface may allow the user to enter a star-based rating, an alphanumerical-based rating, or a textual-statement based rating according to different transaction categories and/or a list of predefined statements. Once entered, at 370 the verified transaction and opinion generation system 210 may generate and publish a professionally edited statement based on the predefined list of statements as selected by the user. Once generated, the verified transaction and opinion generation system 210 may calculate an incentive earned by the user based on user preference information, whether the user has elected to participate in a particular incentive program, and/or based on characteristics of the transaction (e.g., a dollar amount) or the general usefulness of the rating.

FIGS. 4A, 4B, 5A, and 5B show illustrative electronic receipts according to aspects of the disclosure. In some cases, the e-text receipt may be sent by the verified transaction and opinion generation system 220 via the communication network (e.g., the web interface 228) for viewing via a web browser, to the opinion application 112 running on the for viewing in a user interface screen, and/or via a text messaging system (or other messaging system) for viewing by the user on the user device 110 and/or for soliciting user inputs to verify the purchase. For example, FIGS. 4A and 4B may show illustrative e-text receipt formats that may be viewed via a web browser, a user interface screen of the opinion application 112, and/or a messaging system. FIGS. 5A and 5B show illustrative e-text receipt formats that may be viewed in a mobile device text messaging system (e.g. a messaging application on a mobile phone, tablet, wearable computing device, and/or the like). The e-text receipt may include information that may allow a user to properly verify (or identify as fraudulent) a transaction to a financial account associated with their user profile. For example, the e-text receipt may include fields corresponding to a date of purchase, a time of purchase, a financial institution identifier (e.g., a financial institution name, a credit card name, a payment provider name, etc.), a receipt or transaction identifier, a customer name identifier (e.g., the user's name, a user account name, a user identifier, a user email account, etc.), a merchant or service provider name, a purchase amount name, a merchant logo, an account balance, an account identifier, and/or the like. In some cases, the e-receipt may include one or more user input fields (e.g., “yes”, “no”, etc.) that may solicit user input corresponding to whether “I made this purchase”, “I would like to post my opinion”, “I would like to save/archive my receipt”, and/or the like. In some cases, the e-text receipt may include an input that may allow a user to register or otherwise opt-in to provide a verified opinion statement for this and/or other transactions. In some cases, the e-text receipt may include contact information for the merchant, service provider, and/or the financial institution to allow the user to directly contact the appropriate party regarding the transaction.

In some cases, such as shown in FIGS. 5A and 5B, the e-text receipt may prompt the user for entry of a text or numerical input, such as by using a messaging system. In some cases, the e-text receipt may include one or more links that may open the opinion application or a web browser to display the requested information. In an illustrative example, the messaging application screen 500 may show an e-text receipt displaying a text message response 505 to be sent by the user to either verify or deny (e.g., “yes”, “no”, etc.) making the associated transaction. For example, if the user responds with “yes”, the verified transaction and opinion generation system may mark the associated transaction as being verified and may associate the verified transaction to the user, the merchant, the product, and optionally to a product class, or other such categories. If the user 105 responds with “no” to deny making the transaction, the verified transaction and opinion generation system 220 may mark the transaction as “not verified” and will not allow the user to generate a verified opinion statement. In some cases, denied transactions may be responded to with a prompt for additional user action (e.g., “please call your bank to report this fraud immediately”, a contact number at the financial institution, etc.). In some cases, may include API functionality that send additional notification of the denied transaction to one or more other parties as specified by the user. In some cases, the e-text receipt message may include links 555 to verify the transaction, as well as accepting an associated text message verification. In some cases, a merchant and/or financial institution logo 575 may be embedded in the background of the e-text receipt.

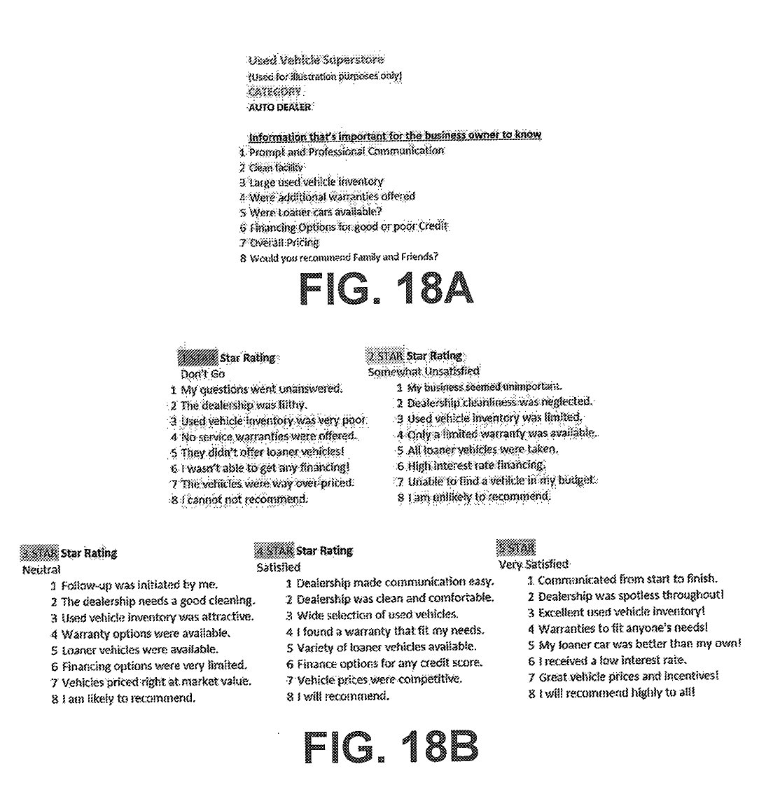

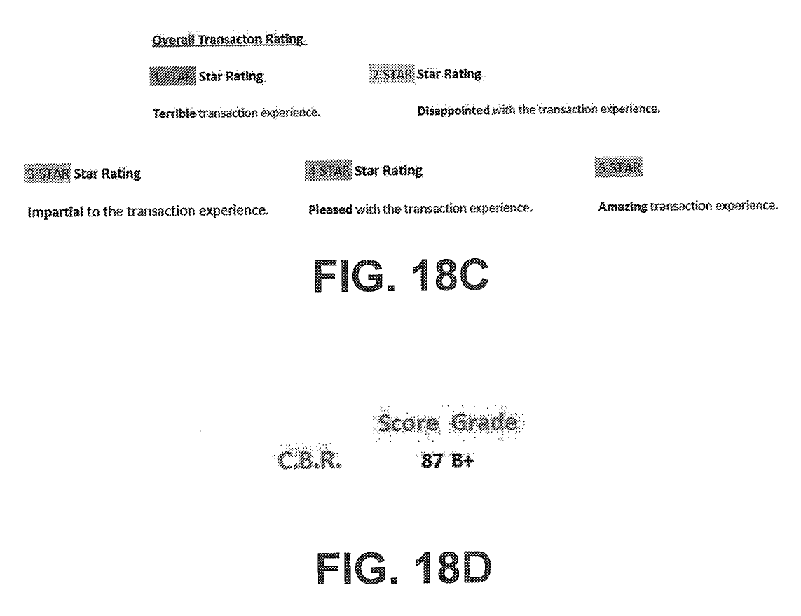

Upon receiving and validating an e-text receipt, customers may be prompted, via a link 515 in the e-text receipt, a user interface screen, and/or the like, to fill out an electronic opinion statement form. In some cases, an algorithm may be used to guide the purchaser through articulating their transaction opinion using one or more predefined selectable statements, discussed with reference to FIG. 18 below. Completing the electronic opinion statement form causes the opinion generation system to create a professional-looking, meaningful, and useful perspective about a business, the product or service purchased, and/or the transaction experience as a whole, before publishing the statement form.

In some cases, the verified transaction and opinion generation system 220 may process instructions implementing an algorithm for converting one or more consumer transaction statements received via the network 115 (e.g., the Internet) into a proprietary numeric score (discussed further below), which may then be used for issuing grades for distinct areas of business, creating a combined overall merchant services and transaction score and/or an associated grade (e.g., A-F), along with a published validated opinion statement. The system may import the e-text receipt transaction data to the opinion statement form (e.g., receipt identifier, OpinionShield™ customer identifier, date and/or time of purchase, purchase cost, purchase location, product type, etc.). This API, or functional based interface, may allow for a private label or white label licensing opportunity, thus allowing at least a portion of the distributed electronic transaction verification and transactional opinion computing system to be distributed by integrating at least some functionality into remote computing systems. Such functionality may also be used as a bridge for other survey or statistical computing systems provided by external corporations and/or government agencies. The system allows for either touch or optimized digital content for speech-based opinion transaction statements, allowing for not just keyword queries, but so consumer opinion statement content can be discovered by electronic personal assistants and/or the like

In some cases, a portion of the electronic transaction verification and transactional opinion computing system may be implemented on a user device, such as by using a mobile device application, a software package, and the like (e.g., the opinion application 112). For example, an OpinionSheild™ mobile application may make it easy for customers to register, configure and/or interact with the electronic transaction verification and transactional opinion computing system via a plurality of user interface screens. In some cases, a web browser interface 228 may be used to facilitate user communication via the Internet or other communications networks. In some cases, the verified transaction and opinion generation system 220 and/or the electronic transaction and opinion management system 120 may provide a secure interface into the system (e.g., a secure web interface, a secured communication channel, etc.) such that merchants (e.g., a merchant subscriber, a consumer, etc.) to privately search and view consumer opinion statements about themselves and/or merchants, and may be used for providing businesses and/or consumers with information that may be used just prior to deciding whether to conduct business with one or more consumers and/or business organizations.

In some cases, the transaction authentication system may convert one or more electronic opinion statements into a proprietary numeric score. This score may correspond to an issued consumer business rating (“CBR”) numeric score (e.g., a 10-point scale, a 100-point scale, etc.) that may be used to generate an associated raging grade (e.g., scored A-F), before publishing the CBR score and/or the grade. Each of the electronic opinion statements may be associated with a numeric value (e.g., 1 star=2 points, 2 stars=4 points, etc.), so that a total numeric score can be generated by summing, or otherwise combining, each numeric score of electronic opinion statements selected by the user. These scores may allow the merchant to easily view an overall score associated with their service and/or a score relating to different aspects of their products and services provided. In some cases, the CBR scores may also provide an electronically auditable record of customer experience to provide an easily communicated and quantifiable record of consumer sentiment towards the merchant for use by third parties (e.g., commercial lenders, etc.). In an illustrative example, ratings statements selected by a user may have a combined numeric score of 8.5 out of a possible 10 points, a combined numeric score of 87.5 out of a possible 100 points, and/or the like. In some cases, the numeric score of different rating statements may be combined with a weighting factor based on a number of factors including importance to the merchant, accuracy of the statement, time elapsed between the transaction date and the date entering the opinion, etc. For example, an illustrative CBR score may be CBR =a*x₁+b*x₂+ . . . , where a and b are weighting factors and x₁ and x₂ are numeric values associated with a ratings statement. In some cases, the weighting factor may be a value between 0 and 1, or other such numeric value.

In some cases, the newly obtained transaction grade may be added into the business's overall consumer business rating score, thus creating a new overall consumer business rating. Similarly, outdated transaction scores and/or grades may be systematically removed. For example, a consumer may have an updated user experience and/or may modify a review or generate a new review of the merchant to provide valuable feedback into the products and/or services provided by the merchant. The removal may cause re-adjusting the overall merchant's rating and creating a foundation for the “consumer business rating.” The transaction authentication system may archive this information in the data center as a disinterested third party for future marketing, statistical analysis, and other business purposes. By associating the numeric CBR scores to verified user opinions and/or transaction information, the ratings provide rich data history stored at a central location and easily accessible to multiple interested parties to provide an efficient and fast method of evaluating a merchant's or consumer's activities over time.

In some cases, consumers may not obtain e-text receipts until the consumer agrees to “opt-in” and/or register to use the transaction authentication system. The registration and/or opt-in functionality may allow for the integration of licensed e-text receipt format outputs. The transaction authentication system is then implemented after testing is performed. To finalize this process, participating parties will issue their consumers an online transaction authentication system registration link, via text and/or email.

In some cases, upon receiving the transaction authentication system registration link, customers be redirected to an incentive and registration page. In some cases, one or more incentives may be displayed to re-enforce the usefulness and purpose of registration. To register, customers may select and enter a unique identifier (user name) and password, along with any additional required personal information. The customer may then select one or more personalized broadcast preferences, that may relate to distributing their verified transaction opinion and/or business transaction grade to a selected party, such as a transacting party (e.g., the merchant, business, service provider, etc.) only, or to the transacting party and to a public online forum. In some cases, the user may select to post one or more of their verified opinions, where their identification has been hidden from public view (e.g., an anonymous entry). To finalize their registration, the customers may be offered a choice as to whether to opt-in with the online verified opinion website. If so, one or more incentives may be offered to the user and/or the user may become eligible to receive one or more incentives. These incentives may include, but are not limited to, special sale pricing on select products, limited time offers, dining offers, travel offers, home-related offers, vehicle related offers, personal grooming offers, and the like through affiliate marketing channels. In some cases, the opt-in selection may allow user information to be used for other general corporate operational purposes, including for generating and/or testing improvements to the electronic transaction verification and transactional opinion computing system.

Once registered with the transaction authentication system, consumers may receive an e-text receipt associated with a corresponding card purchase, in the form of a message (e.g., a text message and/or an email, and the like). Upon authorizing the transaction (e.g., selecting one of “Yes, I made this purchase”) or “No, I did not make this purchase”), the consumer may choose to fill out an opinion statement form to make comments regarding the product, the purchase experience, the transacting business, and the like.

In some cases, such as upon choosing to fill out an opinion statement form, the verified transaction and opinion generation system 220 may import and/or populate the text transaction identifier with the e-text receipt data, customer identifier, and other customer data to the electronic opinion statement form. The system, and or the consumer, may select an identification of a transaction type (e.g. retail, professional service, food & beverage, personal services (home, auto, beauty, etc.), health, travel & accommodations, entertainment & events, etc.), and the industry identifier. The consumer may choose to fill in the opinion statement form on a personal mobile device via a stand-alone application, such as the opinion application 112, as shown in the figures. In some cases, the consumer may choose to access and/or fill in the opinion statement via a network connected user interface device, such as a personal user device with a web browser interface.

An advantage of using the system features, is the use of the algorithm that guides the customer through the opinion statement form, allowing the individual to insert their opinions about the transaction experience into a useful and suitable perspective, prior to publishing to the public or to the transacting business. The opinion statement form may include a plurality of questions predetermined questions that may be based on a product, service, and/or a category of products and services, such as those shown in FIG. 18. The predetermined questions each may be associated with a plurality of predetermined answers. The plurality of answers may be generally predefined so that users may select an answer best describes their personal experiences, in relation to which question is being addressed. However, the user may also be permitted to write their own custom answers providing more direct content to the owner or assigned management. In some cases, the custom answers entered by the user may only be viewed by the transacting partner of the consumer for that particular transaction. The customer may choose to fill out their transaction statement immediately or to save the form for future completion, (e.g., within three business days, within another predetermined time period, etc.).

With respect to FIG. 18, each category of transactions (e.g., Automotive, Food and Beverage, Travel and Leisure, etc.), may have associated information that may be useful in providing feedback to a merchant or service provider. For example, for the illustrative Auto Body Repair category shown in FIG. 18, such information may include:
Communications: appointment setting, email, text, online phone, etc.
Customer Service: prompt friendly service? Experience or knowledge of employee.
Were you satisfied with the quality of the repair?
Were you adequately informed during the repair process?
Did the repair facilities use OEM parts?
Cleanliness of the vehicle upon return?
Additional work required after the repair?
Recommendation?

For each of the above points, a user may be provided an opportunity to give a rating (e.g., a star rating, a numerical rating, a letter grade, etc.) and/or pick a text statement corresponding to their opinion. For example, if the user was neutral (e.g., 3 star rating) regarding the merchant's communication methods, the user may select a 3-star rating and/or may select a statement such as “The repair was sufficient and the work completed as communicated.” If the user selects the 3-star rating associated with the communications, an opinion statement may be automatically generated using the corresponding statement. Similarly, if the user selects the textual statement, the system may automatically generate a 3-star rating for communications regarding the transaction. The user may select as many or as little of the categories to rate, and the system will calculate the rating based on the selections used. Similarly, the system will automatically generate and publish the opinion statement using the pre-defined statements associated with each of the knowledge items defined for each business category.

In some cases, the consumer may select their broadcast preference regarding publication of the verified opinion statement upon completion of the opinion statement form. The transaction authentication system may then convert the electronic opinion statement generated using one or more of the pre-determined statements into an alphanumeric score (e.g., a letter grade between A-F, a numeric score between 1-10, a numeric score between 1-100, etc.). Correspondingly, the transaction authentication system may also be used by the provider of the product and or service. For example, the provider of the product or service may be prompted to enter their own opinion of the transaction with the consumer. In some cases, the questions and/or answers may be pre-selected similarly to the statements to be chosen by the consumer when articulating their opinion, actions, and/or initiatives. The business owner or management team may also subscribe and register with the transaction authentication system to enable a private search and view verified consumer opinions statements about their products or services, about other merchants, as well as dispute customer opinions. Based on the ratings by the businesses, consumers may receive their own user rating or grade, based on the verified business opinions and/or based on the customer-entered reviews. The transaction authentication system may archive all information in the data center for use in improving the system and/or for allowing a disinterested third party to perform statistical analysis, and other calculations on the information, which may be scrubbed of personal identifying information.

In some cases, the electronic transaction verification and transactional opinion computing system may optimize digital content for speech-based queries, as well as keyword queries. This allows content to be discovered by personal assistants on smartphones, smart watches, etc. (e.g. Siri). In some cases, each business sector may require different consumer statement sections (retailer, professional services, food & beverage, etc.). As such, the plurality of questions asked on the opinion statement form may vary dependent upon which consumer segment and/or transaction type took place. Such questions may include, but are not limited to:
“Was your purchase experience positive, neutral or negative?”;
“Will you do business with this business again?”;
“Will you recommend your friends to this business”;
“If your experience was negative, would you allow the business to correct the issue?”

A value will be associated with the answer to each question, allowing the system to generate the alphanumeric score, which may then be generated into an associated transaction grade (e.g., A-F, 1-10, 1-100, etc.).

As shown in the figures, a distributed electronic transaction verification and transactional opinion computing system may include different components configured to perform at least a portion of the process to create verified transaction and opinion, using the pre-specified information provided by the consumer, data providers, and data integrations, the components may include customer accessible applications and/or one or more business backend services.

All of the components and integrations may be used to create, operate and support the production, electronic verification and electronic publication of a verified user opinion. For example, the electronic transaction verification and transactional opinion computing system may be used to model and/or market the applied technological process, to create and facilitate use of the online platform and or gateway, that authenticates a purchaser's transactions or transaction alert notifications. By capturing a purchasers purchase details and information about the purchased product, about the service received and about the overall purchase experience, the system may generate proprietary alphanumeric score, which may be used when generating an overall Business Transaction Grade or Consumers Business Rating, (e.g., A-F, 1-10, 1-100, etc.), before publishing the verified opinion to a publically accessible network location (e.g., a website). In an illustrative example, a star rating may correspond to a letter grade (e.g., 1 star=E, 2 stars=D, etc.), and/or a numerical value (e.g., 1 star=2 points, 1 star=20 points, etc.), where an overall score may be determined by combining multiple star, letter and/or numerical ratings.

As part of the process, a message corresponding to electronic authorization may be used to acquire a consumer's publishing rights with respect to particular transactions so that the system may publish the verified consumer opinions, the consumer's personal opinions and/or personal statements about their recent financial transactions. Incentives may be offered in the form of rewards, mileage, points, cash, and the like. By directly or indirectly providing the incentives, the user's opinion may be used when rebroadcasting or publishing the verified opinion either publicly or privately. This process is an electronically collecting, publishing, and archiving product and business feedback from a user wherein the writing and transcribing, prior to and during, publishing, broadcasting, posting, or sharing feedback is shown in a color chosen from a selection of colors and the selection of colors uniquely representing a level of positive or negative feedback.

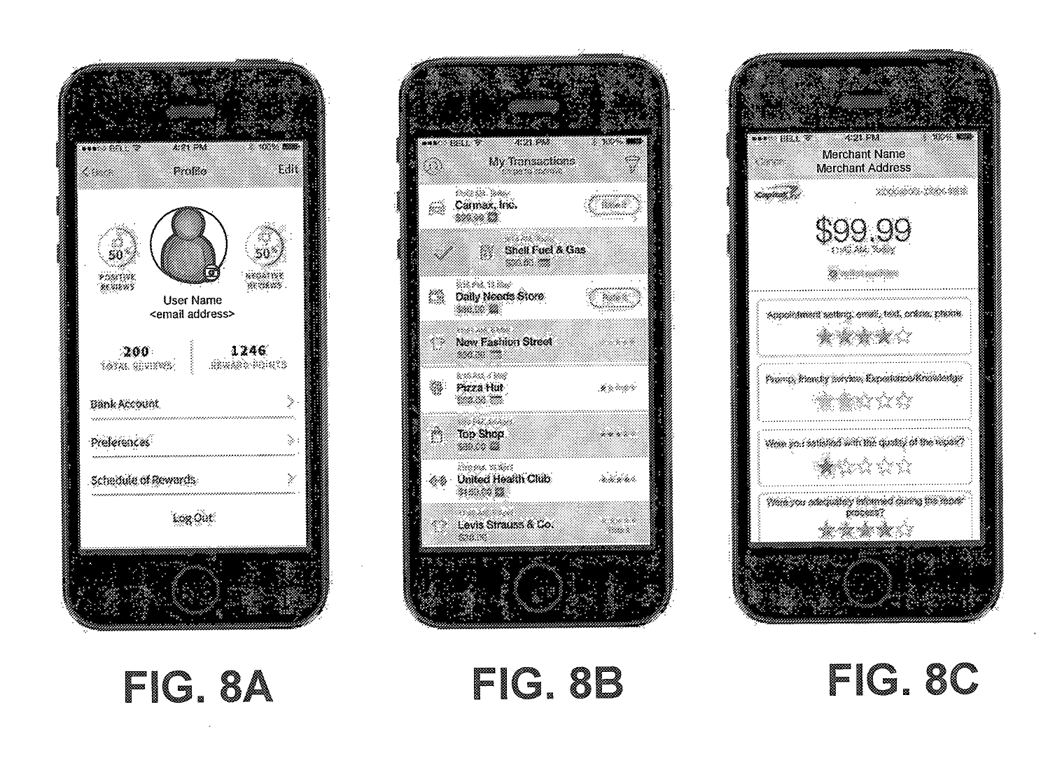

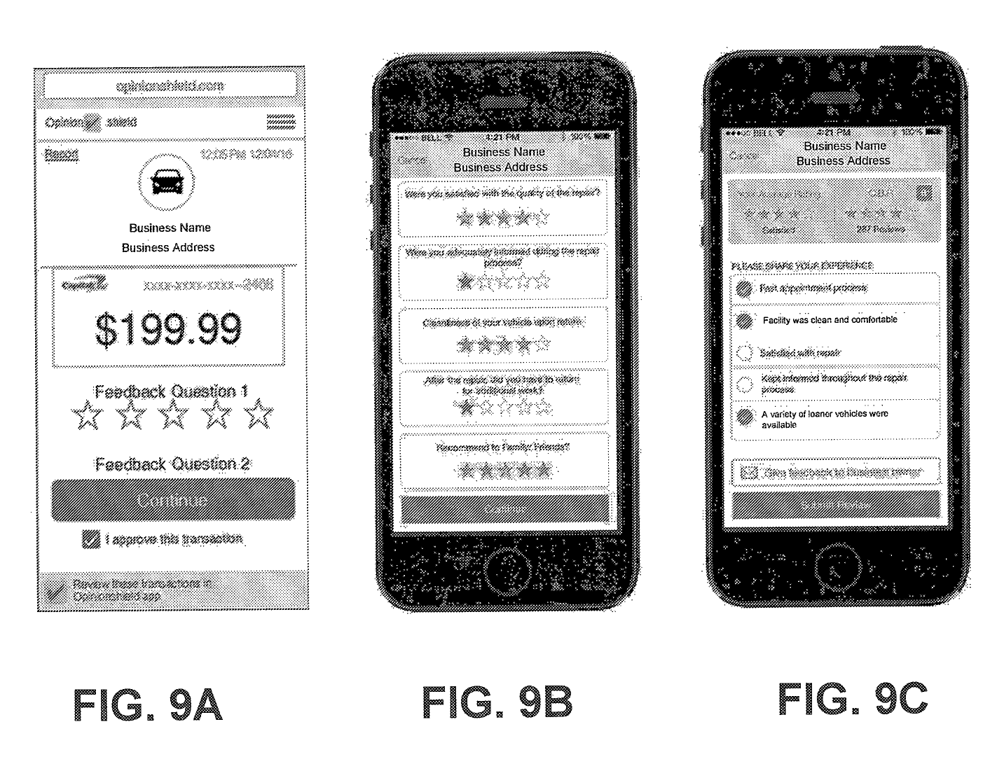

FIGS. 8A-C and 9A-9C show illustrative user interface screens information associated with verified electronic transactions and for providing a verified opinion according to aspects of the disclosure. For example, FIG. 8A shows an illustrative user interface screen displaying a user profile for a user who has opted-in to provide verified opinion statements. For example, this particular user has 200 hundred total reviews, where half were positive and half were negative. The profile screen also may show a total number of incentive points, or other incentive information, as applicable. User inputs may be provided to show and/or modify the linked bank accounts (press “bank account” button, etc.), to show and/or modify the user preference information (press “Preferences” button, etc.), to show and/or modify the incentives and/or rewards (press “schedule of rewards” button, etc.), to show all opinions (press “total reviews” button, etc.), to show earned reward details (press “reward points” button, etc.), to show and/or modify the positive or negative opinions (press “positive reviews” button or “negative reviews” button, etc.). The user may also edit their profile information and/or logout via user inputs displayed on the user interface screen.

Transactions may be shown in a user interface screen listing transactions associated with one or more accounts, such as the user interface screen of FIG. 8B. Here a user may select (e.g., check mark) a transaction for rating. In some cases, all transactions may be verified via the e-text receipt process discussed above before being listed in the user interface screen. In other cases, the user may be able to verify transactions in this or another user interface screen specifically listing unverified transactions. In some cases, a user interface screen may be shown to display any or all transactions denied by the user and, in some cases, a status with the financial institution regarding fraudulent activity associated with the denied transaction(s). In some cases, the user interface screen may display, for each transaction, either an entered verified user opinion rating (e.g., stars, numerical, alphanumerical rating, etc.) and/or a link for use in generating a rating for a particular transaction (e.g., “rate it” button, etc.). Transaction views may be sorted and/or filtered by date, alphabetical order, dollar amount, category, and/or the like based on selected user settings (not shown).

FIG. 8C shows an illustrative user interface screen for use in providing a verified opinion statement. For example, the user interface screen showing a transaction may include the merchant name, address and/or other contact information such as an email address, phone number, web site, and/or the like. Additionally, information may be displayed regarding the financial institution and/or at least a partial identifier of the associated financial account (e.g., a partial credit card number, etc.), the purchase amount and the time and date of the purchase. The user may be presented with one or more grading categories for which the user may select a rating (e.g., number of stars, alphanumerical grade, etc.). The user may enter a value for one or more of the different grading categories. For example, the user selected a 4-star rating concerning “appointment setting, email, text, online, and phone” communications, a two-star rating for “prompt, friendly service”, a one-star rating concerning “were you satisfied with the quality of the repair?”, and a four-star rating for “were you adequately informed during the repair process?”. Such information may provide the merchant with information showing that their communications procedures and employee actions in communicating with customers were very good, but their ability to diagnose and/or complete this type of repair was inadequate and the merchant may need to provide more training to the repair technicians concerning this particular type of repair.

FIGS. 9A-9C show additional user interface screens that may be used to provide a verified opinion statement by the user for a verified transaction according to aspects of the disclosure. In some cases, such as in FIG. 9A, each feedback question may be presented individually, where a user may press a “continue” button to proceed with the review. In some cases, the user interface screen may be displayed in a web browser and may include a link to open the transaction in the application 112 on the user device 110. FIG. 9C shows an illustrative user interface screen allowing a user to select various statements that apply to their experience with the transaction, the product or service, and/or the merchant or service provider. For example, the user interface screen may display a plurality of pre-defined statement that may be combined to describe the user experience to be published as a professionally sounding and edited textual message. For example, the selected statement associated with a selected 4-star rating may read “The appointment process was fast. The facility was clean and comfortable. A variety of loaner vehicles were available.” Such a review will provide useful information regarding the user's experience to both other consumers and to the merchant and provide an indication to the merchant of certain factors most important to that user during their visit. The verified transaction and opinion generation system 220 may use the selected statements to generate an alphanumerical and/or star-based rating upon user submission to the verified transaction and opinion generation system via the network 115. Other statements may be available for selection by scrolling the statements or paging through lists of statements. In some cases, the user may be allowed to select only one statement associated with a particular feedback category, such as those shown in FIG. 18.

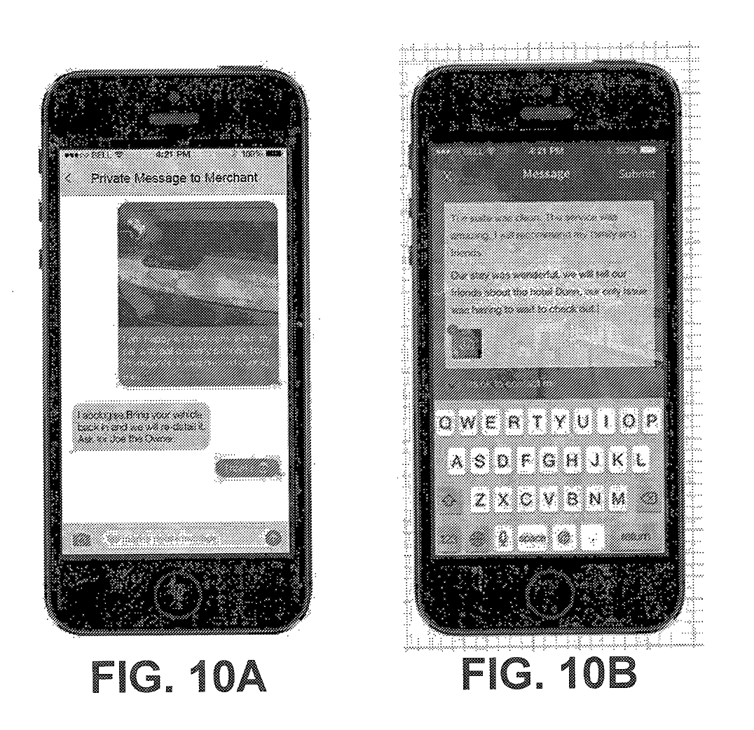

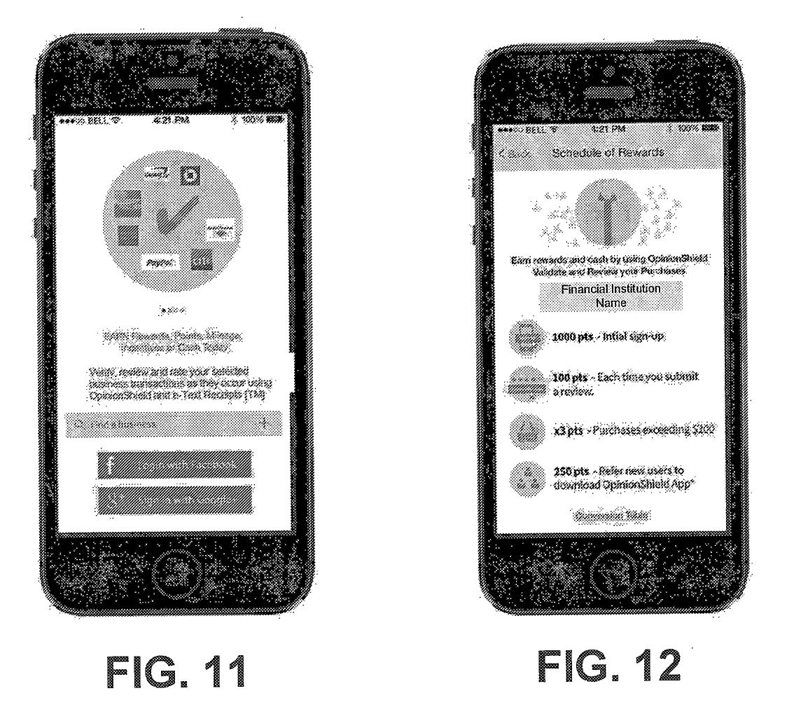

FIGS. 10A and 10B show illustrative user interface screens for providing private messaging between a user with a verified transaction and a provider according to aspects of the disclosure. Additional to the publically published verified statement, the verified transaction and opinion generation system 220 may provide an interface (e.g., a text messaging interface, an opinion application interface, and/or the like) for providing private messages between the consumer and the merchant regarding the transaction and/or the transaction experience. For example, the user may privately discuss what they liked or did not like about the transaction experience. For example, the user may provide further explanation regarding a negative review category (e.g., not properly cleaned car after a repair), and/or acknowledging good work by a particular employee. In such a way, the user and consumer may have a useful and productive dialog via a private messaging environment regarding a verified transaction. FIG. 11 shows an illustrative user interface screen for a business search interface according to aspects of the disclosure. FIG. 12 shows an illustrative incentive overview user interface screen according to aspects of the disclosure. User incentives may be calculated based on a number of reviews posted, quality of reviews posted, whether the user was helpful/not-helpful in private messages with the merchant, and the like.

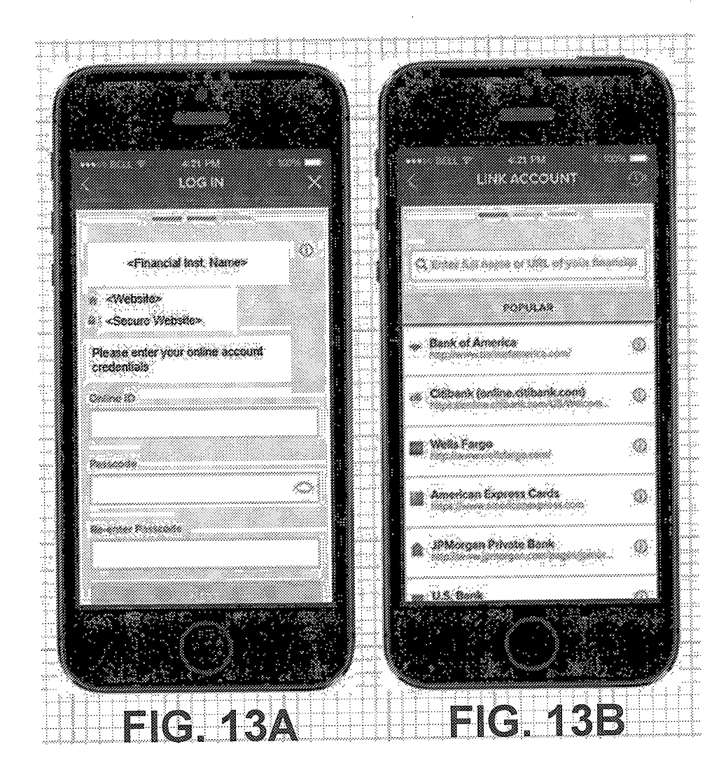

FIGS. 13A and 13B show illustrative user interface screens for to allow a user to associate a financial account to their user profile according to aspects of the disclosure. For example, as discussed above, the user 110 may search via the opinion application 112 on the user device 110, one or more financial institutions at which the user has a financial account. The user device and/or the electronic transaction and opinion management system 120 may provide a secure and/or encrypted communication link via the network 115 to verify the user financial account information to associate each of the user's accounts with their profile. In some cases, the electronic transaction and opinion management system may store the account association information in an encrypted and secure data repository.

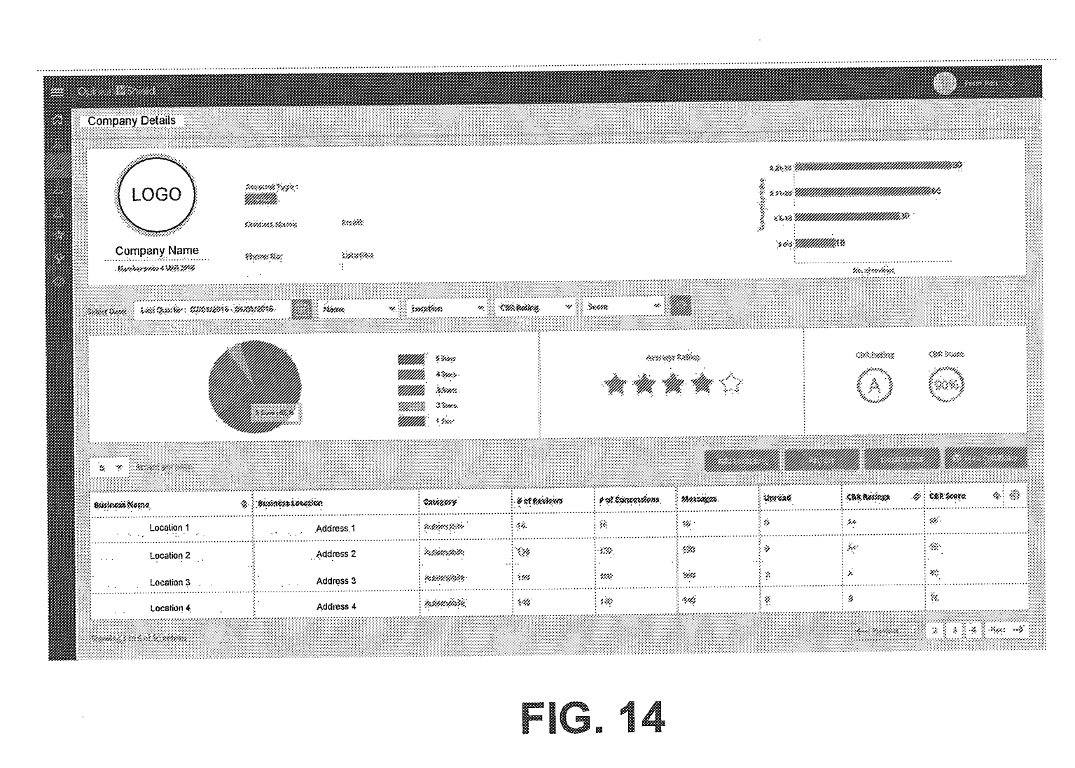

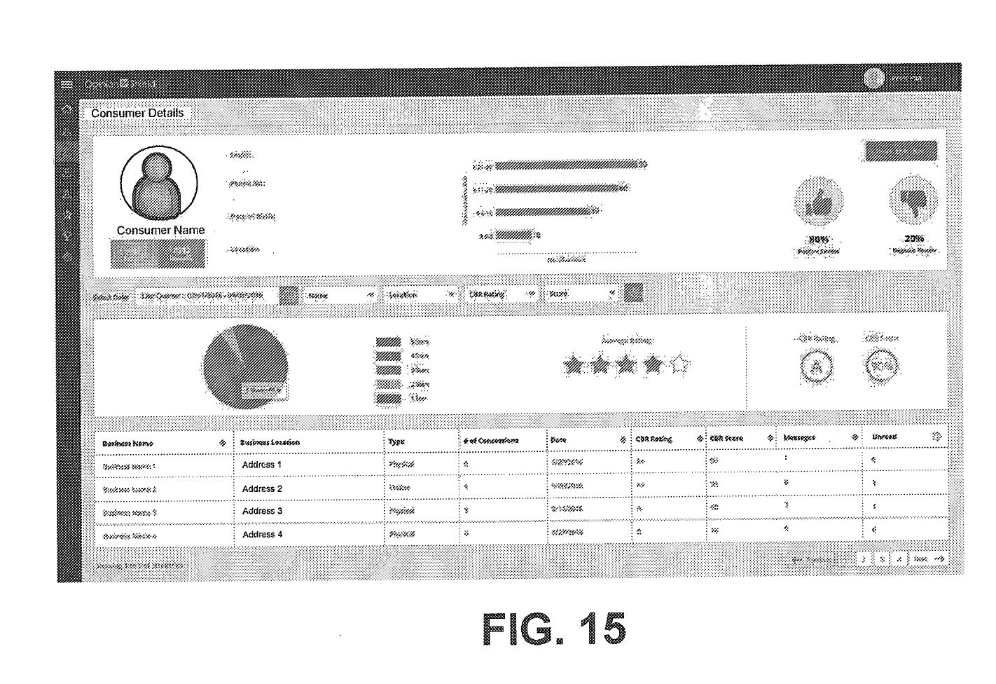

FIGS. 14-17 show illustrative user interface screens showing an overview of company and consumer information according to aspects of the disclosure. For example, FIG. 14 shows an illustrative company profile of a merchant having multiple store locations. The overview screen may be presented to a user via a web browser interface at a user device and/or the administration portal device 127. The company overview screen may be used to provide an overview of the performance of a particular company based on one or more verified reviews. Each verified user review is associated with a verified transaction and may be published with the amount of the verified transaction. As such, the reviews may be broken down by transaction size (e.g., 0-$5, $5.01-$10, $10.01-$20, $100-$500, etc.), where if selected, the rating distribution may be shown or that particular transaction range. In some cases, an overview chart may be shown displaying a number of ratings in relation to the number of stars received. This information may also be shown based on a range of time, such that an improvement or degradation of performance can be calculated over time. An overall star rating for the company, based on an average or other calculation method of the verified user ratings, and an overall alphanumerical grade may be associated with the company, as well. Such information can be valuable as the ratings calculated from the verified user ratings are associated with actual user experiences that are tied to particular transactions, such that the company can identify training opportunities and/or procedural changes that may be made to improve or continue their desired performance. In some cases, each location of a company may be selected to show the verified ratings received for each of the sites, either in the same window or a different window (e.g., a popup window, etc.).

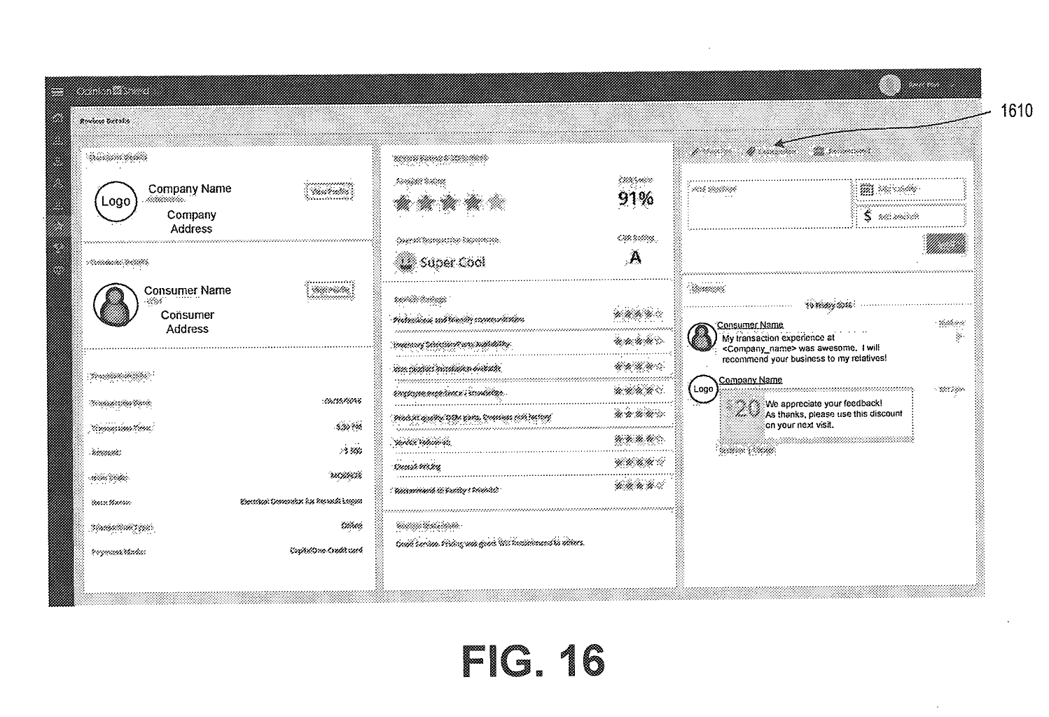

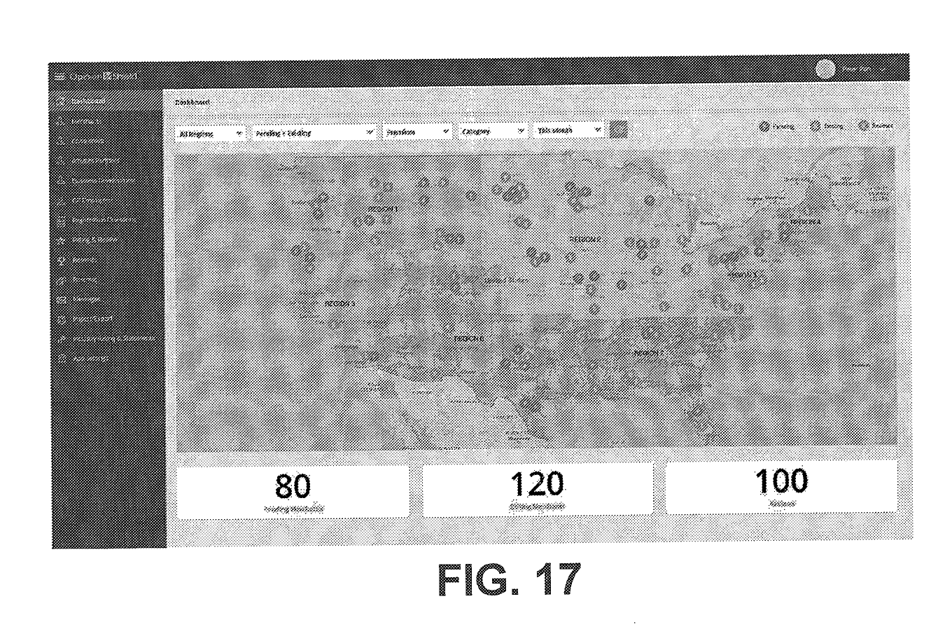

FIG. 14 shows an illustrative consumer profile overview screen according to aspects of the disclosure. For example, the user identification information may be shown as well as an overview of the number of verified opinion statements made by the user and/or a number of reward points earned. As with the company overview page, the consumer ratings may be classified by a transaction type and/or transaction size. In some cases, the number of positive and negative reviews may be shown, either as a total or as a relative percentage of the total. The user is also given a rating based on how valuable the feedback was to the particular business. Each transaction with a business that the user has provided a verified opinion statement may be listed and may be shown in a same or different screen upon selection, such as in FIG. 16. For example, the verified opinion statement may be shown along with the ratings statements and any private messages between the parties. In some cases, the user and/or business may be capable of viewing this page and communicate to the other party via the messaging interface. In some cases, a merchant may wish to provide one or more concessions and/or rewards to a user. The user interface screen of FIG. 16 may include a concessions interface 1610 that may be used to keep an auditable record of one or more concessions provided by the merchant, where each concession is associated with a verified transaction and/or opinion statement. Such concessions may be stored in a data repository to allow for a historical record of all granted concessions that have been associated with a verified transaction. FIG. 17 shows an illustrative overview map showing locations and/or categories of business and/or consumers participating in the electronic transaction verification and a verified opinion system 100. For example, locations and/or categories of businesses may be shown based on a number of display filters. Similarly, consumers providing highest and/or lowest ratings may be shown in relation to the businesses they have rated.

Although the innovative concepts discussed in this disclosure have been explained in relation to certain embodiments, it is understood that many other possible modifications and variations can be made without departing from the spirit and scope of the disclosure as herein described.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A transactional opinion computing system comprising:
a processor;
a non-transitory memory device storing instructions that, when executed by the processor, cause the electronic transaction verification and transactional opinion computing system to:
detecting an executed transaction;
transmit, to a user device via a first communication network, a message including information corresponding to the executed transaction comprising an indicator that uniquely identifies the executed transaction;
receive, from the user device via the first communication network, an electronic verification message verifying the executed transaction;
cause, at the user device in response to verifying the executed transaction, display of a user interface screen corresponding to the executed transaction, the user interface screen including a plurality of user-selectable input elements, each for selecting one of a plurality of pre-defined ratings statements;
receive, from the user device via a second communication network, a plurality of user inputs, each user input corresponding to a selection of one of the pre-defined ratings statements;
generate a verified opinion statement based on the plurality of user inputs received; and
publish, via the second communication network, the verified opinion statement on a publically accessible webpage with a numeric rating corresponding to the plurality of user inputs received and selecting one of the plurality of pre-defined ratings statements.

2. The transactional opinion computing system of claim 1, wherein the first communications network comprises a telecommunications network and the second communications network comprises an Internet connected network.

3. The transactional opinion computing system of claim 1, wherein the instructions, when executed by the processor, transactional opinion computing system to:
cause display, via the user device, a user interface screen presenting a user agreement granting electronic publication rights in one or more verified opinion statements generated by the user and a user input to confirm grant of publication rights by the user; and
receive, via the second communications network, the user input to confirm grant of the publication rights by the user.

4. The transactional opinion computing system of claim 1, wherein the message comprises an e-text receipt including a purchase indicator, a link to an internet accessible user interface screen to enter a validated user opinion, and a prompt for user input to be sent in response to the message, the user input verifying or denying the executed transaction.

5. The transactional opinion computing system of claim 4, wherein the message includes a first link for verifying the executed transaction via the second communications network and a second link for denying the executed transaction via the second communications network.

6. The transactional opinion computing system of claim 4, wherein the message includes a link to archive the purchase indicator in a remote data repository corresponding to a user profile associated with the user device.

7. The transactional opinion computing system of claim 1, further comprising an application running on the user device, the application to display the user interface screen corresponding to the executed transaction.

8. The transactional opinion computing system of claim 7, wherein the instructions, when executed by the processor, transactional opinion computing system to:
display, via the user device, a user registration user interface screen including fields for user identification information; and
display, via the user device upon entry of user identification information in associated fields, a user input field for accepting a user input associated with user acceptance of terms and conditions for publishing the verified opinion statement.

9. The transactional opinion computing system of claim 7, wherein the instructions, when executed by the processor, cause the transactional opinion computing system to:
calculate, based on the verified opinion statement associated with the executed transaction, a reviewing incentive; and
display, at the user device, the reviewing incentive.

10. A method comprising:
detecting a first executed transaction;
transmitting, to a user device via a first communication network, a first message including information corresponding to the first executed transaction and comprising an indicator that uniquely identifies the first executed transaction;
receiving, from the user device via the first communication network, a first electronic verification message verifying the first executed transaction;
causing, at the user device in response to verifying the first executed transaction, display of, a user interface screen corresponding to the first executed transaction, the user interface screen including a plurality of user-selectable input elements, each for selecting one of a plurality of pre-defined ratings statements;
receiving, from the user device via a second communication network, a plurality of user inputs, each user input corresponding to a selection of one of the pre-defined ratings statements;
generating, a first verified opinion statement based on the plurality of user inputs received; and
publishing, via the second communication network, the first verified opinion statement on a publically accessible webpage.

11. The method of claim 10, comprising:
detecting a second executed transaction;
transmitting, to a user device via a first communication network, a second message including information corresponding to the second executed transaction comprising a second indicator that uniquely identifies the second executed transaction;
receiving, from the user device via the first communication network, a second electronic verification message verifying the second executed transaction;
causing, at the user device in response to verifying the second executed transaction, display of a user interface screen corresponding to the second executed transaction, a plurality of user-selectable input elements, each for selecting one of the pre-defined ratings statements;
receiving, from the user device via a second communication network, a plurality of user inputs, each user input corresponding to a selection of one of the pre-defined ratings statements;
generating a second verified opinion statement based on the plurality of user inputs received; and
publishing, via the second communication network, the second verified opinion statement on a publically accessible webpage.

12. The method of claim 11 comprising:
calculating, based on selected predefined rating statements, a first rating associated with the first verified opinion statement;
calculating, based on selected predefined rating statements, a second rating associated with the second verified opinion statement; and
displaying in a user interface screen, the first rating and the second rating.

13. The method of claim 11, wherein the verification message includes a user-selected input indicating that the user granted exclusive publishing rights to one or more opinion statements generated by the user.

14. The method of claim 11 wherein the first rating and the second rating corresponds to a consumer providing the user inputs that is associated with one of the first executed transaction and the second executed transaction.

15. The method of claim 10, wherein the first communications network comprises a telecommunications network and the second communications network comprises an Internet connected network.

16. The method of claim 10, wherein the first communications network comprises a text messaging communications link.

17. An apparatus comprising
a processor;
a non-transitory memory device storing instructions that, when executed by the processor, cause the apparatus to:
detect an executed transaction;
transmit, to a user device via a first communication network, a message including information corresponding to the executed transaction comprising an indicator that uniquely identifies the executed transaction;
receive, from the user device via the first communication network, an electronic verification message verifying the executed transaction;
cause, at the user device in response to verifying the executed transaction, display of a user interface screen corresponding to the executed transaction, the user interface screen including a plurality of user-selectable input elements, each for selecting one of a plurality of pre-defined ratings statements;
receive, from the user device via a second communication network, a plurality of user inputs, each user input corresponding to a selection of one of the pre-defined ratings statements;
generate, a verified opinion statement based on the plurality of user inputs received; and
publish, via the second communication network, the verified opinion statement on a publically accessible webpage.

18. The apparatus of claim 17, wherein the message comprises an e-text receipt including information associated with the executed transaction, a link to an internet accessible user interface screen to enter a validated user opinion, and a prompt for user input to be sent in response to the message, the user input verifying or denying the transaction.

19. The apparatus of claim 16, wherein the message includes a first link for verifying the executed transaction via the second communications network and a second link for denying the executed transaction via the second communications network.

20. The apparatus of claim 18, wherein the message includes a link to archive the message comprising a purchase indicator in a remote data repository corresponding to a user profile associated with the user device.

21. The apparatus of claim 17, further comprising an application running on the user device, the application to display the user interface screen corresponding to the verified executed transaction.

22. The apparatus of claim 1, wherein instructions that, when executed by the processor, cause the apparatus to:
cause, at the user device, display of a messaging interface screen providing a private messaging interface associated with the verified opinion statement, wherein the private messaging interface facilitates private communication between the user device and a merchant computing system associated with the executed financial transaction.
